(19) United States
(12) Patent Application Publication
(10) Pub. No.: US 2017/0192720 A1
(43) Pub. Date: Jul. 6, 2017

(54) PRIORITIZATION OF ORDER IDS IN DRAM SCHEDULING

(71) Applicant: Benjamin (Byung-chul) Hong, Seongnam-si (KR)

(72) Inventor: Benjamin (Byung-chul) Hong, Seongnam-si (KR)

(73) Assignee: Arteris, Inc., Campbell, CA (US)

(21) Appl. No.: 15/393,283

(22) Filed: Dec. 29, 2016

Related U.S. Application Data
(60) Provisional application No. 62/274,126, filed on Dec. 31, 2015.

(51) Int. Cl. G06F 3/06

(52) U.S. Cl. CPC G06F 3/0659; G06F 3/0608; G06F 3/0673

(57) ABSTRACT

A DRAM scheduler that prioritizes pending transactions based on their order ID value. The order of prioritization of ID values changes from time to time. Changes affecting any particular pending ID value occur only when no requests of that ID value are pending.

### FIELD OF THE INVENTION

This application claims the benefit of U.S. Provisional Application Ser. No. 62/274,126 filed on Dec. 31, 2015 with title PRIORITIZATION OF ORDER IDS IN DRAM SCHEDULING by Benjamin Hong, the entire disclosure of which is incorporated herein by reference.

### FIELD OF THE INVENTION

The present invention is in the field of semiconductor chips, and particularly in the field of scheduling requests to DRAM memories.

### BACKGROUND

It is increasingly common for chips with DRAM memory channels to have more than one channel. This is particularly true for chips with HBM and HMC memory interfaces. Within the chip, each channel has a scheduler. Schedulers determine the order in which to issue requests when more than one is pending. Initiators such as CPUs, GPUs, and DMA controllers issue requests and sometimes require that certain requests receive responses in the same order that the requests were issued. With each request, initiators assert an ID value. Requests with the same ID value must receive responses in the same order as their requests were issued. DRAM schedulers are free to respond to requests with different ID values in any order. No particular ID value has any greater importance or priority than any other.

In systems with multiple DRAM channels, different requests with the same ID value from an initiator may go to different DRAM channels. In some cases, the requests from an initiator are sent to different DRAM channels because of their addresses. In some cases, single initiator requests are split into multiple requests to different DRAM channels.

DRAM channels are independent, and make independent scheduling decisions. Scheduling is generally based on prioritizing request that hit in open pages, prioritizing requests that use idle banks, prioritizing requests in order to group reads and writes, and in some cases prioritizing requests based on an associated urgency. Often a response to a later request to one DRAM channel would arrive at the initiator before the response to an earlier request to another DRAM channel. A reorder buffer between the initiator and the DRAM channels can correct the ordering of such responses. A reorder buffer stores early responses to later requests while a response to an earlier request of the same ID is still pending.

Reorder buffers must allocate at lease enough storage space for every request pending that is not one the sequence of the requests to the earliest DRAM channel with a pending request prior to a request to any other DRAM channel. That is true for every ID value for which there are requests pending to more than one DRAM channel. That is a very large amount of space in modern system that have many initiators competing for access to DRAM channels, and relatively long response times. For most initiators, which is the target DRAM channel of any particular request is typically essentially random. For most DRAM schedulers, the order of responding to requests of different ID values is essentially random. Therefore, the amount of time that space must be allocated for any particular ID is long. As a result, a lot of reorder buffer storage space is required to provide for high performance requirements of initiators.

### SUMMARY OF THE INVENTION

The present invention is directed to decreasing the amount of storage space required by reorder buffers to meet performance requirements. That is accomplished by decreasing the time that requests of certain ID values have pending requests that require allocating reorder buffer storage space. That is accomplished by giving some ID values higher priority than others within DRAM schedulers, particularly when all other scheduling criteria provide no other preference.

### BRIEF DESCRIPTION OF THE DRAWINGS

The invention is described in accordance with the aspects and embodiments in the following description with reference to the figures, in which like numbers represent the same or similar elements, as follows:

FIG. 1 illustrates a timeline scenario of spread out responses from DRAM channels to an initiator.

FIG. 2 illustrates a timeline scenario of temporally clustered responses from DRAM channels to an initiator.

FIG. 3 illustrates a timeline scenario of requests of different IDs to two DRAM channels without prioritization of responses based on order IDs.

FIG. 4 illustrates a timeline scenario of requests of different IDs to two DRAM channels with prioritization of responses based on order IDs.

### DETAILED DESCRIPTION

Reference throughout this specification to “one embodiment,” “an embodiment,” or similar language means that a particular feature, structure, or characteristic described in connection with the various aspects and embodiments are included in at least one embodiment of the invention. Thus, appearances of the phrases “in one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention. To the extent that the terms “including”, “includes”, “having”, “has”, “with”, or variants thereof are used in either the detailed description and the claims, such terms are intended to be inclusive in a similar manner to the term “comprising”.

In accordance with various aspects and some embodiments of the invention, logical connectivity exists between all components or units, except for connectivity between coherence controllers and except for connectivity between memory interface units. This high degree of connectivity may be advantageous in some systems for minimizing latency. An example configuration includes: three agent interface (AI) units, two coherence controllers (CC), and two memory interface (MI) units. In such a configuration, one possible method of operation for a read memory request is as follows:

1. Agent interface units send read requests to coherence controllers.

2. Coherence controllers send snoops to as many agent interface units as necessary.

3. Agent interface units snoop their agents and send snoop responses to coherence controllers and, if the cache line is present in the agent cache, send the cache line to the requesting agent interface unit.

4. If a requested cache line is not found in an agent cache then the coherence controller sends a request to the memory interface unit.

5. The memory interface unit accesses memory, and responds directly to the requesting agent interface unit.

A possible method of operation for a write memory request is as follows:

1. Agent interface units send write requests to coherence controllers.

2. Coherence controllers send snoops to as many agent interface units as necessary.

3. Agent interface units snoop their agents and cause evictions and write accesses to memory or, alternatively, forwarding of data to the requesting agent interface unit.

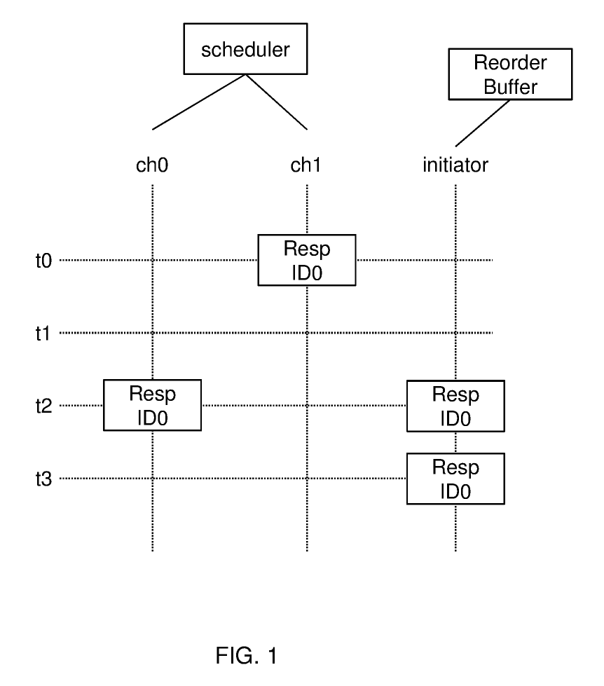

The time to deallocation of reorder buffer storage space depends on the time until the last response from the sequence of requests to the earliest DRAM channel with pending requests. FIG. 1 shows scenario with long allocation time. The scenario begins with two requests pending, one was issued first to DRAM channel ch0, and another was issued later to DRAM channel ch1. The reorder buffer allocated a buffer entry. At times t0, ch1 provides its responses, which is buffered. DRAM channel ch1 does not provide a response until time t2. The reorder buffer provides its responses to the initiator at times t2 and t3, only deallocating the buffer entry at time t3.

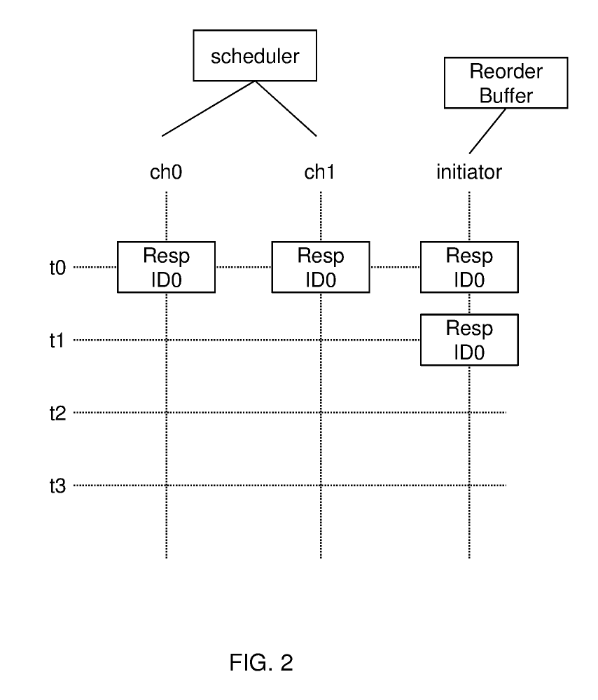

FIG. 2 shows a scenario with a shorter allocation time. The scenario begins with two requests pending, one was issued first to DRAM channel ch0, and another was issued later to DRAM channel ch1. The reorder buffer allocated a buffer entry. At times t0, ch0 and ch1 provides their responses. The reorder buffer stores the response from ch1 and provides the response from ch0 to the initiator. The reorder buffer provides the responses from ch1 at times t1 and deallocates the buffer entry. In the scenario of t2, the buffer was allocated for ½ as many cycles, which allows the initiator to issue requests with other IDs using that buffer. The initiator needs less buffering to meet its performance requirements and its performance can be higher with the amount of buffer space available.

The invention enables earlier deallocation of some IDs in order to provide availability for other IDs. This is the result of schedulers, according to the invention, giving priority to requested with some IDs over requests with other IDs.

Different embodiments have different numbers of ID bits. In one embodiment, the number of ID bits is 4, which allow for up to 16 different pending non-reorderable sequences (numbered 0 to 15). The scheduler gives priority to ID value 15 over 14, 14 over 13, 13 over 12, and so forth, giving priority to 1 over 0. This has the effect of creating temporal clustering of requests based on ID value.

The DRAM scheduler make decisions on a cycle by cycle basis based on the attributes of pending requests and the expected state of the DRAM memory resulting from previously issued requests. For any particular scheduling decision, different embodiments give different priority of consideration to different state factors such as open pages, idle banks, previous requesting being a read or write, among others. Different embodiments also give different priority of consideration to different attributes of each pending request such as whether it is a read or write, its starting byte address, its length, its priority indicator, which initiator made the request, among others. The order of priority of consideration of request attributes varies between embodiments. So, too, does the ID value attribute according to the invention.

One embodiment considers the ID value attribute last. That is, the prioritization of one ID value over another determines the scheduler's choice of pending request to issue only when all other factors give equal weight to two or more requests of highest priority. By considering the ID value last, the efficiency of the utilization of the DRAM interface is not affected, since other factors related to efficiency are considered first. In some embodiments, the benefits of better performance/area efficiency outweigh relatively small decreases to DRAM interface efficiency, and therefore the priority of the consideration of ID value over other factors is worthwhile for overall system performance.

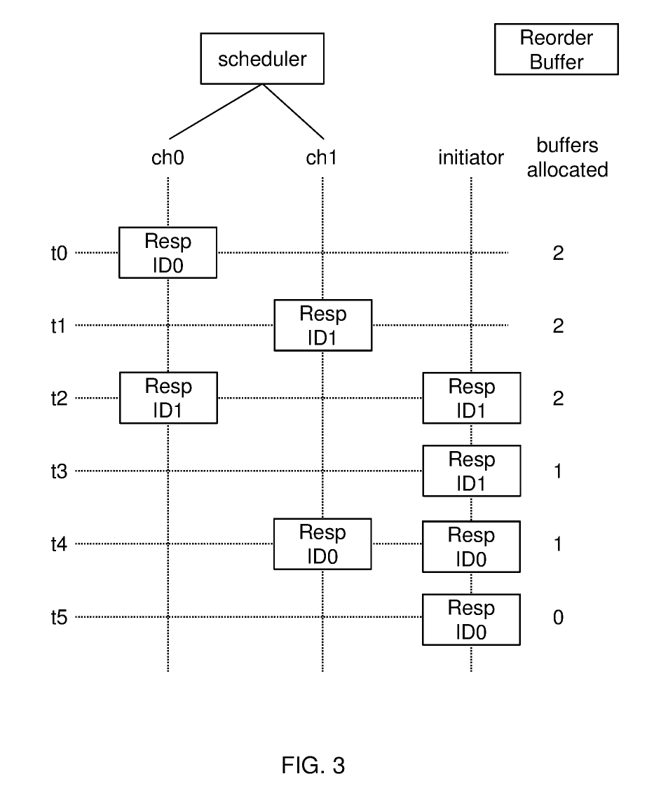

FIG. 3 shows a scenario without prioritizing requests by their order ID. It begins with two request, one request of ID value 0 and one request of ID value 1 pending to each of two DRAM channels. The reorder buffer allocates two buffers in case the order of DRAM channel responses of both IDs is out of the order that the initiating requests were issued. In the scenario of FIG. 3, at time t0 channel 0 responds to ID 0 out of order and the reorder buffer stores the response in a buffer. At time t1 channel 1 responds to ID 1 out of order, and the reorder buffer stores the response in a buffer. At time t2 channel 0 provides the response to the first request with ID 1, and the reorder buffer passes it directly to the initiator. At time t3 the reorder buffer provides the second response to the ID 1 request and deallocates the buffer, but backpressures DRAM channel 1. At time t4 channel 1 provides the response to the first request with ID 0, and the reorder buffer passes it directly to the initiator. At time t5 the reorder buffer provides the second response to the ID 0 request and deallocates the last buffer. The total time to respond to both transaction is 5 cycles, and during that time 8 buffer-cycles are used.

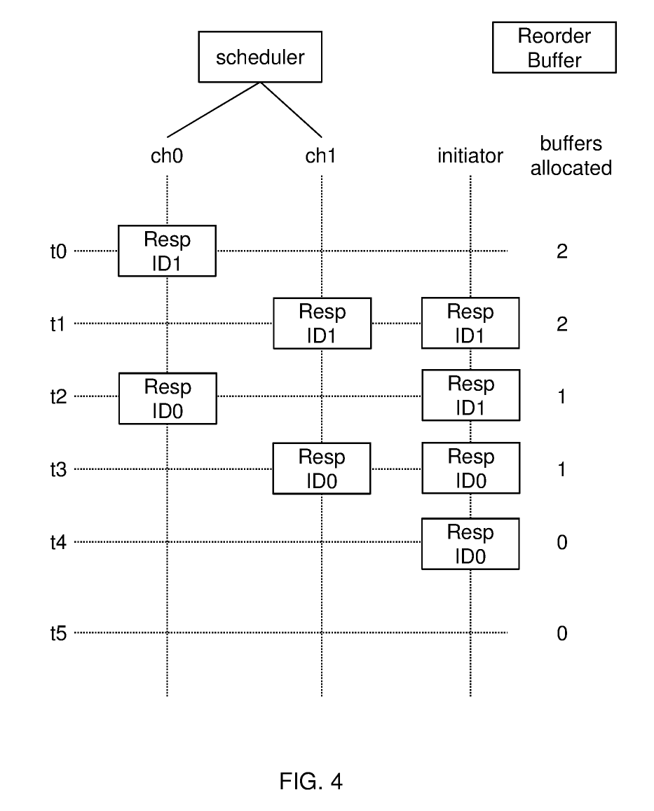

FIG. 4 shows a scenario, according to an embodiment of the invention, in which DRAM schedulers prioritize requests of ID 1 over request of ID 0. It begins with two request, one request of ID value 0 and one request of ID value 1 pending to each of two DRAM channels. The reorder buffer allocates two buffers in case the order of DRAM channel responses of both IDs is out of the order that the initiating requests were issued. In the scenario of FIG. 4, at time t0 channel 0 responds to ID 1 out of order and the reorder buffer stores the response in a buffer. At time t1 channel 1 responds to ID 1, and the reorder buffer passes it directly to the initiator. At time t2 channel 0 responds to ID 0 out of order and the reorder buffer stores the response in a buffer. Meanwhile, the reorder buffer provides the second response for ID 1 to the initiator and deallocates a buffer. At time t3 channel 1 responds to ID 0, and the reorder buffer passes it directly to the initiator. At time t4 the reorder buffer provides the second response to the ID 0 request and deallocates the last buffer. The total time to respond to both transaction is 4 cycles, and during that time 6 buffer-cycles are used. This provides a significant performance/buffer improvement over a system without ID value prioritization.

One effect of request prioritization based on ID value is that it gives an unfair advantage to some requests over others whereas the request protocol intends fairness. Some embodiments improve fairness by mapping the IDs of requests from the initiator to possibly different request IDs in the DRAM scheduler, and, from time to time, changing the mappings. Thereby, at different times, different ID values from an initiator effectively have different priority over others. Statistically, over sufficiently long amounts of time, this method improves fairness between different initiator request IDs. Some embodiments further improve fairness between multiple initiators by considering both an initiator ID and request ID in the mapping to scheduler request IDs.

According to some embodiments, mapping is accomplished by applying a rotating hashing function to a concatenation of the initiator ID and order ID. If the number of ID bits considered by the scheduler is less than the sum of the number of initiator ID bits and order ID bits, then there is a possibility for multiple initiator IDs to be mapped to the same scheduler ID. That somewhat reduces the amount of temporal clustering of requests by order ID value.

The optimal times at which to change the prioritization of ID values depends on the application, its pattern of requests, and its fairness requirements. In some embodiments, ID value prioritization changes occur at regular time intervals. In other embodiments ID value prioritization changes occur in response to events or particular states.

The various aspects of the invention, as well as the various embodiments, include a transport network for communication using the various channels. A transport network is a component of a system that provides standardized interfaces to other components and functions to receive transaction requests from initiator components, issue a number (zero or more) of consequent requests to target components, receive corresponding responses from target components, and issue responses to initiator components in correspondence to their requests. A transport network, according to some embodiments of the invention, is packet-based. It supports both read and write requests and issues a response to every request. In other embodiments, the transport network is message-based. Some or all requests cause no response. In some embodiments, multi-party transactions are used such that initiating agent requests go to a coherence controller, which in turn forwards requests to other caching agents, and in some cases a memory, and the agents or memory send responses directly to the initiating requestor. In some embodiments, the transport network supports multicast requests such that a coherence controller can, as a single request, address some or all of the agents and memory. According to some embodiments the transport network is dedicated to coherence-related communication and in other embodiments at least some parts of the transport network are used to communicate non-coherent traffic. In some embodiments, the transport network is a network-on-chip with a grid-based mesh or depleted-mesh type of topology. In other embodiments, a network-on-chip has a topology of switches of varied sizes. In some embodiments, the transport network is a crossbar. In some embodiments, a network-on-chip uses virtual channels.

The physical implementation of the transport network topology is an implementation choice, and need not directly correspond to the logical connectivity. The transport network can be, and typically is, configured based on the physical layout of the system. Various embodiments have different multiplexing of links to and from units into shared links and different topologies of network switches.

System-on-chip (SoC) designs can embody cache coherence systems according to the invention. Such SoCs are designed using models written as code in a hardware description language. A cache coherent system and the units that it comprises, according to the invention, can be embodied by a description in hardware description language code stored in a non-transitory computer readable medium.

Many SoC designers use software tools to configure the coherence system and its transport network and generate such hardware descriptions. Such software runs on a computer, or more than one computer in communication with each other, such as through the Internet or a private network. Such software is embodied as code that, when executed by one or more computers causes a computer to generate the hardware description in register transfer level (RTL) language code, the code being stored in a non-transitory computer-readable medium. Coherence system configuration software provides the user a way to configure the number of agent interface units, coherence controllers, and memory interface units; as well as features of each of those units. Some embodiments also allow the user to configure the network topology and other aspects of the transport network.

Some typical steps for manufacturing chips from hardware description language descriptions include verification, synthesis, place & route, tape-out, mask creation, photolithography, wafer production, and packaging. As will be apparent to those of skill in the art upon reading this disclosure, each of the aspects described and illustrated herein has discrete components and features, which may be readily separated from or combined with the features and aspects to form embodiments, without departing from the scope or spirit of the invention. Any recited method can be carried out in the order of events recited or in any other order which is logically possible.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention is not intended to be limited to the various aspects and embodiments discussed and described herein. Rather, the scope and spirit of invention is embodied by the appended claims.

What is claimed is:

1. A system-on-chip comprising:
a plurality of DRAM channels;
a scheduler coupled to each DRAM channel and enabled to issue any of multiple pending requests in an optimal order;
a reorder buffer coupled to each DRAM channel and enabled to receive responses from the plurality of DRAM channels; and
at least one initiator coupled to the reorder buffer,
wherein the scheduler, when having no higher priority deciding criteria, issues pending requests in the same order based on order ID.

2. A DRAM scheduler that, when having no higher priority deciding criteria, chooses from a plurality of pending requests based on a value of an order ID of each of the plurality of pending request.

3. The DRAM scheduler of claim 2 that, from time to time, changes the order of prioritization of the order ID.

4. A non-transient computer readable medium that stored hardware description language code that describes a DRAM scheduler that, when having no higher priority deciding criteria, chooses from a plurality of pending requests based on a value of an order ID of each of the plurality of pending request.
